(19) United States
(12) Patent Application Publication
(10) Pub. No.: US 2007/0129933 A1
(43) Pub. Date: Jun. 7, 2007

(54) System, method, and article of manufacture for a deterministic speech patern detection system that eliminates a need for employing bilingual persons in an enterprise

(76) Inventor: Afrouz Nikmanesh, Irvine, CA (US)

Correspondence Address: Afrouz Nikmanesh, #G434, 2967 Michelson Dr., Irvine, CA, 92612, US

(21) Appl. No.: 11/294,320

(22) Filed: Dec. 5, 2005

(51) Int. Cl. G06F 17/20

(52) U.S. Cl. 704/8

(57) ABSTRACT

This invention discloses a deterministic speech pattern detection system that can be implemented in an enterprise to eliminate a need for employing bilingual employees. The system includes a transcript that contains questions and answers pertaining to the task to be performed. The system can be utilized to enable a person, conversing in a first language, to sustain a coherent conversation with another person who converses in a second language. Using the repetition of phrases, patterns, and high-frequency words that occur in a business related transaction to advantage, the system enables the first person to accomplish the task without the need for becoming fluent in the second language.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a system that eliminates a need to employ bilingual persons in an enterprise. More particularly this invention is related to utilizing a deterministic speech pattern system to sustain a coherent conversation between two persons that converse in different languages.

### BACKGROUND

Enterprises routinely employ bilingual individuals to engage in a business interaction where a purchase or a service is to be performed. In most circumstances, the interaction includes verbal exchange that contains a deterministic pattern. Such pattern may or may not be a function of the business of the enterprise, but nonetheless, it is predictable.

An enterprise's choice of potential employees is reduced by requiring bilingual persons. Furthermore, a bilingual employee's compensation is also higher than it would otherwise be, especially, if the employee is a highly skilled individual. The enterprise's requirement for such individual is predicated on the individual's professional skills and not on the individual's fluency in foreign languages. However, in this era of diversity, many businesses, regardless of the nature of their business activities, must interact with persons that do not speak the formal language or are otherwise incapable of interacting without using their own language. Establishing such interactions also improves customer relations. Moreover, there are occasions where a special need arises for an employee to engage in a verbal exchange with a customer that speaks a different language, during the ordinary course of business, even though the employee is not expected to know the different language. Therefore, there is a need for a process that an enterprise can implement that eliminates the need for employing a bilingual person.

### SUMMARY

The present invention discloses a system, method, and article of manufacture, which can be implemented in an enterprise to eliminate a need to employ bilingual persons. The system relies on the fact that in certain enterprises, transactions, whether service or sale, comprise verbal exchanges that include phrases, patterns, and high-frequency words. Accordingly, a transcript that includes such verbal exchanges contains a substantial amount of the speech required to enable an employee who speaks in a first language to converse with a customer who speaks in a second language. In one embodiment the employee is provided with a transcript that is drafted in a foreign language containing questions and answers pertaining to a transaction. The employee views or listens to the transcript on a tangible medium and asks the questions in order to retrieve the answers. In another embodiment, the employee memorizes the transcript prior to the encounter and uses the memorization to converse with the customer

### BRIEF DESCRIPTION OF THE DRAWINGS

FIG. 1 is a diagram depicting one preferred embodiment of a system implementing the method according to the present invention.

FIG. 2. shows a flow diagram of one preferred method of eliminating a need to employ a bilingual person in an enterprise according to the present invention.

FIG. 3. is a diagram depicting two different enterprises implementing the method according to the present invention.

FIG. 4. is a diagram depicting three different departments of an enterprise implementing the method according to the present invention.

FIG. 5. is a diagram depicting a transcript drafted in a foreign language spoken by a customer utilizing the letters of the foreign language according to the present invention.

FIG. 6. is a diagram depicting a transcript drafted in a foreign language spoken by a customer using the letters of a formal language spoken by an employee according to the present invention.

### DETAILED DESCRIPTION OF THE PRESENTLY PREFERRED EMBODIMENTS

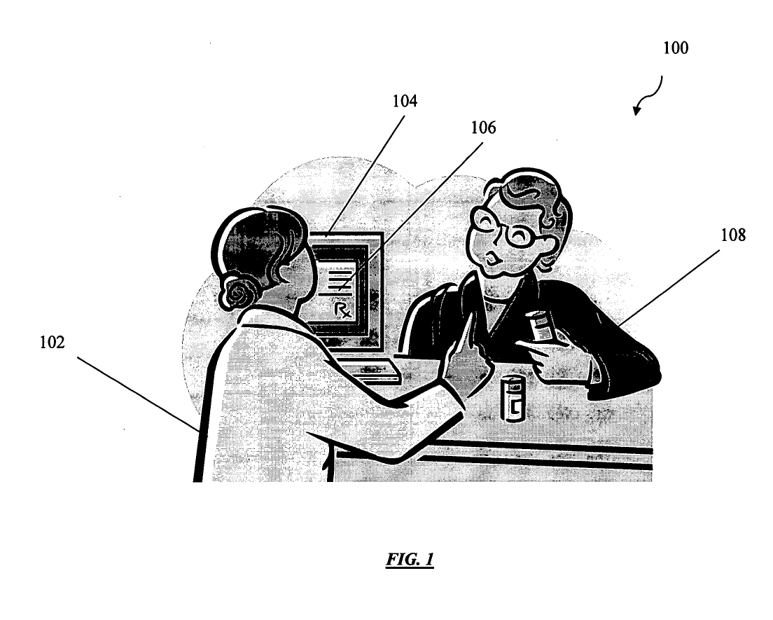

FIG. 1 depicts a diagram of one preferred embodiment of a system 100 implementing a method for eliminating a need to employ a bilingual person according to the present invention. The system 100 shows an employee 102, who is fluent in a first language, but only slightly familiar with a second language spoken by a customer 108. According to this embodiment, a computer screen 104 is utilized to show a transcript 106 to assist the employee 102 to interact with the customer 108.

In one instance, the employee 102 speaks English fluently, but is only slightly familiar with Spanish, the language spoken by the customer 108. A transcript 106 is generated and displayed on the computer screen 104, wherein, due to the deterministic nature of the questions and answers, said transcript enables the employee 102 to sustain a coherent conversation with the customer 108. In one embodiment, the conversation is limited to questions and answers that pertain to the nature of the transaction.

According to one example, the enterprise is a pharmacy, where the employee 102 is a pharmacist and must interact with the customer 108 in a foreign language. The employee 102 is provided with the transcript 106 via the computer screen 104. Due to the fact that the customer 108's speech for that transaction is repetitious, the transcript 106 contains a substantial amount of the speech. Accordingly, the employee 102 may utilize the transcript 106 as displayed on the computer screen 104, to assist her to converse with the customer 108.

According to a variation of the present method, the employee 102 may be provided with the script 106 at an earlier time and wherein the employee 102 has viewed and/or listened to the transcript 106 prior to the encounter with the customer 108. The employee 102 may have enough familiarity with the language spoken by the customer 108 such that she may be able to converse with the customer 108 without viewing the transcript 106 on the computer screen 104.

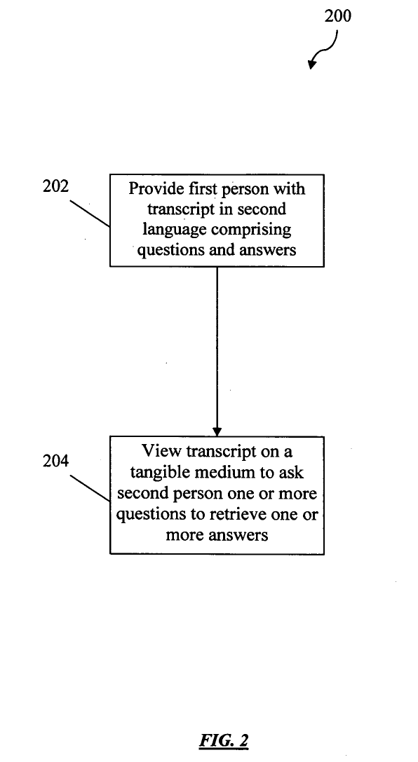

FIG. 2 shows a flow diagram 200 of one preferred method of eliminating a need to employ a bilingual person in an enterprise according to the present invention. According to this method, an employee is provided with a transcript at 202, wherein the transcript is drafted in a foreign language that the employee is only slightly familiar with. The transcript comprises questions and answers that include phrases, patterns, and high-frequency words that typically occur in a conversation pertaining to the transaction. The employee views the transcript to ask the customer one or more questions regarding the transaction in order to retrieve one or more answers to the one or more questions.

According to one variation of the present method, the employee may listen to a transcript, recorded on a tangible medium such as a compact disc or a magnetic tape and played via a CD player or a tape player. The employee repeats what she hears, which is what is transcribed in the transcript, namely one or more questions that pertain to the nature of the transaction, in order to retrieve one or more answers to the questions. In this manner, the employee may converse with the customer within the framework of the transcript, without her being fluent in the language spoken by the customer.

According to another variation of the present method, the employee may be provided with a transcript written on paper or recorded on a CD prior to the encounter. The employee memorizes the transcript and utilizes said memorization to converse with the customer. As discussed above, the deterministic nature of the conversation, the questions, and the answers make it possible for the employee to converse with the customer.

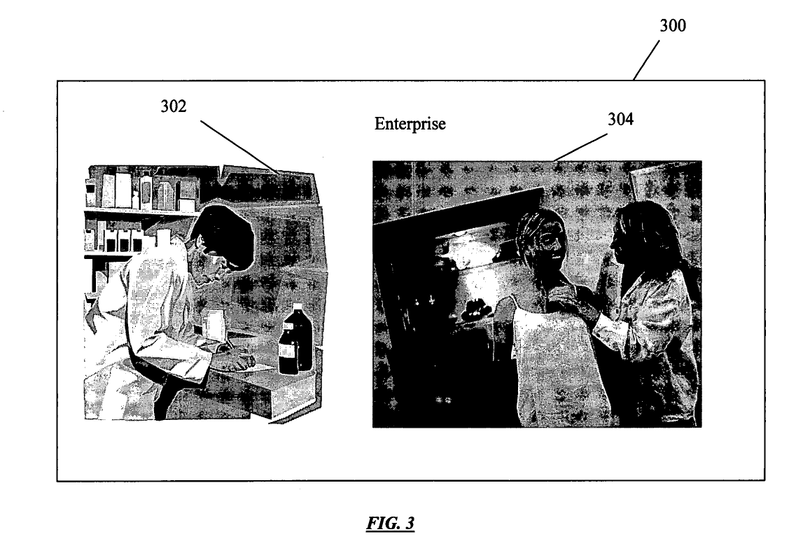

FIG. 3. is a diagram depicting two different enterprises 300 implementing the method according to the present invention. In certain businesses, such as a pharmacy 302 and department store 304, only a limited vocabulary is required to carry out a service or sale. Accordingly, the employee's familiarity with a foreign language may be minimal or nonexistent. Therefore, even employees who are not familiar with the foreign language may utilize the present method in certain enterprises to converse with their customers.

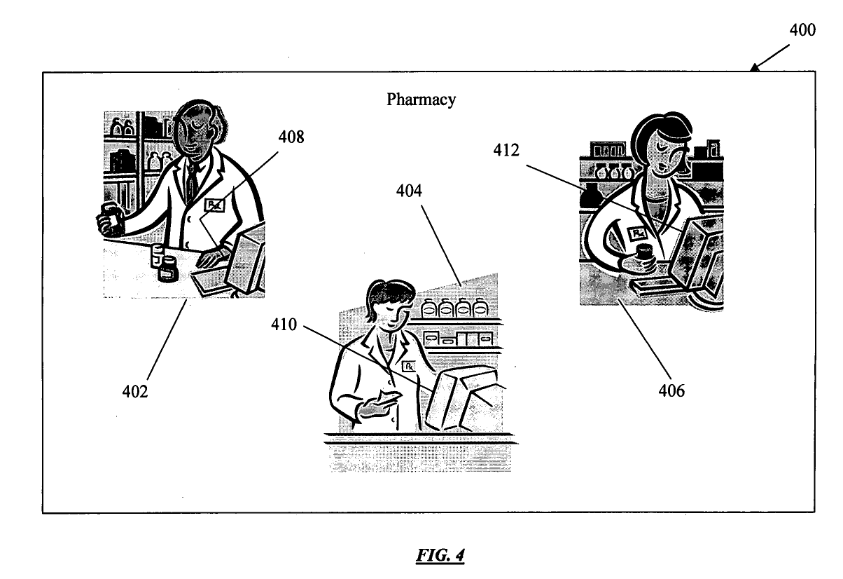

FIG. 4. is a diagram depicting three different departments of an enterprise 400 implementing the method according to the present invention. According to one example of the present embodiment, the enterprise 400 is a pharmacy wherein an employee compartment comprises three different sections, a drop-off window section 402, a pick-up window section 404, and an inside section 406. A transcript comprising three different sections, each comprising one or more questions and one or more corresponding answers may be implemented. According to this embodiment, the transcript comprises a drop-off window section 408 pertaining to a speech pattern related to the drop-off window section 402, a pick-up window section 410 pertaining to a speech pattern related to the pick-up window section 404, and an inside section 412 pertaining to a speech pattern related to the inside section 406. The following are sections of an illustrative transcript comprising several scenarios that may occur during a business transaction, wherein “R” is for speech used by an employee and “P” is for speech used by a customer:

At the Drop-Off Window

Scenario #1:
R: Good Morning. Is this prescription for yourself or someone else?
P: It is for me.
R: Have you ever been to this pharmacy?
P: No I have not.
R: Please provide me with your address, phone number and birth date. You can write them down on the prescription. Can you also print your first and last name on the prescription? Here is a pen.
P: Ok. Here is the information.
R: Thank you. Do you have any drug allergies?
P: No I do not.
R: Do you have insurance?
P: Yes I do.
R: May I have your insurance card please.
P: Here you go
R: Are you the primary card holder or the dependant?
P: I am the primary policy holder. Can you tell me how much that medication would cost?
R: No. Not until I process it through your insurance. They determine how much you would have to pay out of pocket.
P: How long would that be?
R: About 20-30 minutes. Would you like me to page you once it is done?
Pt: Yes please. Thank you

Scenario #2:
R: Good Afternoon. Is this prescription for you or someone else?
P: It is for my wife.
R: Have we filled prescriptions for her before?
P: No. You have not.
R: Please provide me with her address, phone number, and date of birth. You can write that information on the prescription. Can you also print her first and last name on the prescription please? Here is a pen.
P: Ok. Here you are
R: Thank you. Does she have any drug allergies?
P: Yes. She is allergic to Penicillin and Sulfa drugs.
R: Does she have insurance?
P: Yes she does.
R: Can I have her insurance card please?
P: Here you go.
R: Who is the primary card holder?
P: My wife is the policy holder. By the way can you tell me how much that would be?
R: No. Not until I process the prescription through your insurance. Your insurance determines how much you would pay out of pocket.
P: How long would that be?
R: About 20-30 minutes. Would you like me to page you once it is done?
Pt: Yes please. Thank you

Scenario #3
R: Good Evening. Have you been to this pharmacy before?
P: Yes. I have.
R: Is this prescription for you or someone else?
P: It is for me.
R: I am sorry I can not read the doctor's handwriting. What is the name on the prescription?
P: My name is Juan Lopez.
R: What is your date of birth or phone number?
P: My birth date is Jul. 10, 1968 and my phone number is (949) 555-2345.
R: All right. I have found you in the computer. Please give me about an hour to get this ready.
P: By the way I have a new insurance.
R: Can I please have your insurance card.
P: Here you are.
R: Thank you. We close at 6:00 pm. Please make sure you come back by 6.
P: I will thank you.

Scenario #4:
R: Good day. Have you been to this pharmacy before?
P: Yes. One of these is for my daughter and the other one is for my son.
R: Ok. What is your daughter's date of birth?
P: Her birth date is May 15, 2000.
R: And your son's?
P: His birth date is Jun. 16, 2002.
R: Is the address and phone number we have for you current?
P: What information do you have for me?
R: I have your address as: 12345 Santiago Road in the city of Orange and your phone number as (999) 999-9999.
P: No. I need to give you my new home address and phone number.
R: Ok. Please write that information on the prescription.
P: Ok. Here you are. How long would that be?
R: A couple of hours.
P: I will pick them up tomorrow.
R: Thank you and have a nice day.

Scenario #5:
P: Good Morning. I need a refill on my prescription. Here is my bottle.
R: Ok. It will be ready in 45 minutes.
P: I have one more medication but I throw away the bottle.
R: No problem. I can look it up for you. Do you the name of it?
P: No. But I know I take it for my cholesterol.
R: Ok. I see that you have a prescription for Mevacor, but it does not have any refills left on it so we need to call your doctor to ask for more refill.
P: Do you know how long that would take?
R: No. It is up to your doctor's office. Please call us before you come back to make sure that they have authorized the refill.
P: Thank you. I will call back later on today. How late are you open till?
R: We are open until 7 pm.
P: And what time do you open in the morning?
R: We open at 9 am.
P: Thank you.
R: You are welcome.

Scenario #6:
P: Good afternoon. I need refills on these medications.
R: Seems like you got these at a different pharmacy. Would like to get them transferred over to our pharmacy?
P: What does that mean?
R: That would mean that we have to contact the other pharmacy and get all the information on your prescriptions transferred to our pharmacy. If you have any remaining refills we can then fill your prescriptions here.
P: What happens when I go back to the other pharmacy?
R: Again if you have any remaining refills they contact us to transfer the prescriptions back to them. Oh, I just noticed that one of your prescriptions is for a control substance.
This prescription can only be transferred once and can not be transferred back. Do you still want it transferred?
P: Yes please.
R: Ok. Please give us about 2 hours to take care of these.
P: Thank you. I will be back.

Scenario #7:
R: Good afternoon. Have you been to our pharmacy before?
P: Yes. I have.
R: What is your name and date of birth?
P: My name is Liz Gomez and my birth date is Mar. 2, 1980.
R: Let me make sure that we have this medication in stock. It seems that we need to order this medication for tomorrow. Is that ok with you?
P: Sure. What time should I come by?
R: It should be in late morning or in the afternoon. Please give us a call before coming in. Here is our phone number.
P: Thank you. I will see tomorrow.

At the Pick-Up Window

Scenario #1:
P: Good afternoon. I am here to pick up my mother's medication.
R: What is her name?
P: Her name is Maria Hernandez.
R: What is her birth date?
P: Her date of birth is Aug. 23, 1945
R: Ok. I need you to sign right here for insurance purposes.
P: Do I sign my name or her name?
R: Please sign your name.
P: Can I pay for these other items here?
R: Yes, As long as you have less than 10 items. Your total is $56.32.
P: That seems too high. Is that with her insurance?
R: Yes. She might have a deductible to meet. She can call her insurance if she has any questions.
P: Thank you.

Scenario #2:
P: Good morning. I am here to pick up my medication.
R: What is you first and last name?
P: My name is Juan Hernandez.
R: What is your date of birth?
P: My birth date is Sep. 29, 1969.
R: I am sorry Mr. Hernandez, but your doctor has not called us back yet to authorize your refill.
P: But I am completely out of the medication. It is my blood pressure pills and I can not be without them.
R: That is not a problem. I will give you some pills to hold you for a few days until your doctor calls us back. Please call us before you come back to make sure your doctor has called back to authorize your refill.
P: Ok. Thank you very much.
R: Do you have your bottle with you?
P: Yes I do.
R: I will place 3 days worth of the medication in there for you.
P: Thank you. I appreciate it.
R: No problem. Have a nice day.

Scenario #3:
P: Good Evening. I need to pick up my medication.
R: What is your name?
P: My name is Carlos Lopez.
R: What is your date of birth?
P: My birth date is Sep. 10, 1657.
R: I am sorry Mr. Lopez. But your doctor denied your refill. He wants to see you before authorizing any more refills.
P: But I have an appointment with him on Friday.
R: Would like to talk to them? I can try to get them on the phone for you.
P: Yes please.
R: Ok. They seemed to okay your refill. Please give me 15 minutes to get it ready for you.
P: Thank you.

Scenario #4:
P: I am here to pick up my daughter's medication.
R: What are her name and her date of birth?
P: Her name is Lupe Torres and her birth date is Feb. 03, 2004.
R: I am very sorry. But we are out of that medication. We ordered it for tomorrow and should be able to get it tomorrow afternoon.
P: But that is her antibiotic and the doctor said to start her on it right away. Can I get the prescription back?
R: Of course. Would you like me to call other pharmacies to check if they have it?
P: Yes please.
R: Please give me a few minutes. I will check on that.
P: Thank you.

Scenario #5:
P: I am here to pick up my medication.
R: What is your name and date of birth?
P: My name is Maria Gomez and my birth date is Dec. 24, 1965
R: I am sorry but your insurance does not cover this medication since it is considered a cosmetic treatment. The price on it is $98.25.
P: But I am not using it for cosmetic reasons.
R: In that case your doctor needs to call the insurance for what is called a prior authorization. We can provide your doctor with the phone number to the insurance company and it is up to them to do what is called a prior authorization. We can call you once it is taken care of.
P: That would be nice. Thank you.

Scenario #6:
P: I am here to pick up my medication.
R: What is your name and date of birth?
P: My name is Patricia Gomez and my birth date is Dec. 27, 1942.
R: I am sorry Mrs. Gomez but your doctor wrote a prescription for a medication that is not covered by your insurance. We have contacted your doctor to switch that medication to something similar which would be covered by your insurance.
P: How much would it be for the one that is not covered?
R: It is an expensive medication. The cash price on it would be $156.99
P: Ok. I think I want the doctor to change it to a medication that is covered by my insurance. Thank you.

Scenario #7:
P: I am here to pick up my medication.
R: What is your name and date of birth?
P: My name is Jose Gomez and my birth date is Jan. 8, 1955.
R: I am sorry Mr. Gomez, but it seems that the pharmacist had to call your doctor for some clarification on the name of the medication and on the directions. We are still waiting for your doctor to call us back.
P: How long do think that would be?
R: They said they would call us back in a couple of hours.
P: I will pick it up later on.

Scenario #8:
P: I am here to pick up my medication.
R: What is your name and phone number?
P: My name is Lewis Garcia and my phone number is (213) 265-7894.
R: It seems that the insurance we have for you is no longer valid. Do you have a new insurance?
P: No. My insurance is still valid.
R: Can you please go to the other window. I will verify the information we have for you over there.
P: Ok.
R: Now, the member number we have for you with Blue Cross is 654789231 and your birth date as Apr. 1, 1964. Is that correct?
P: Yes.
R: When we process your prescription with this information they tell us that your coverage terminated on Jun. 1, 2005. You need to contact your insurance and find out what the problem is. We will hold your medication on the shelf for 10 days.
P: Ok. I will look into it.

Inside Section-Answering the Phone

Scenario #1:
R: Good morning. XYZ pharmacy, how can I help you?
P: I need a refill on my prescription.
R: What is your prescription number?
P: It's 687954.
R: What is your last name booth?
P: Rodriguez.
R: Do you need any other medications?
P: Yes. My next number is 687521.
R: You do not have any refills left on this prescription. We need to contact your doctor for more refills. Would you like anything else?
P: yes. I have one more prescription. The number is 625874.
R: This prescription has expired. It was written more than a year ago. We need to contact your doctor to renew it. Would you like anything else?
P: No thank you. How long would it be on the one with refills?
R: Please give us an hour to have that one ready for you. Meanwhile I will call your doctor on the other ones as well.
P: Thank you.
R: You are welcome.

Scenario #2:
P: Good afternoon. I am calling to see if my father's medications are ready.
R: What is your father's first and last name and date of birth?
P: Juan Hernandez and his birth date is Nov. 13, 1933.
R: We have three medications ready for him but the doctor has not called us back on the refill request on his diabetes medication.
P: When did you call the doctor?
R: Seems like we left a message for the office yesterday. I will call again on it today. Sometimes it helps if you call then as well.
P: Ok. I will do so. I will pick the other three for now. How late are you open till?
R: We are open until 9 pm.
P: Thank you.

Scenarios for Over the Counter Products

Scenario #1:
P: My daughter has a fever. What should I give her?
R: How old is your daughter?
P: She is two years old.
R: How long has she had a fever?
P: Since this morning.
R: You can give her xyz. Give her one teaspoonful by mouth every 4-6 hours as needed. Call your doctor if she does not feel better.

Scenario #2:
P: My wife and I have been coughing a lot. What can we take for it?
R: Is it a dry cough or do you also have phlegm?
P: Mine is dry, but my wife has phlegm.
R: Is the phlegm clear or colored, maybe brown, yellow, or green.
P: It is green.
R: Since yours is dry you might want to take xyz but your wife might have an infection. She should talk to her doctor.

Scenario #3:
P: I have a cold what should I take for it?
R: What symptoms do you have?
P: I have a headache, cough, fever, congestion and watery eyes.
R: Do you have high blood pressure?
P: No.
R: Are you a diabetic?
P: No.
R: You can take XYZ.
P: Would that make me sleepy?
R: It could. You can take XXX for daytime.

Scenario #4:
P: My son has diarrhea. What can I give him?
R: How old is your son?
P: He is 15.
R: How long has he had it?
P: A few days.
R: Does he have stomach cramps?
P: No.
R: Has he been vomiting?
P: No.
R: You can give him SSS. Also give him a lot of fluids with minerals in them such sports drinks.

Scenario #5:
P: What is good for constipation?
R: How old is the patient?
P: It is for me and I am 45 years old.
R: How long have you been constipated?
P: About 3 days.
R: How often do you usually to the bathroom.
P: Once a day.
R: Ok. You can take PPP. Take one capsule twice a day and increase you water intake.
P: Would it work right away?
R: Usually no. It takes a few days. For more immediate relief you can take OOO.

Scenario #6:
P: I have a stomachache. What can I take for it?
R: Do you have diarrhea?
P: No.
R: Do you experience acid reflux?
P: What does that mean?
R: Do you feel a sour taste in the back of your throat?
P: Yes.
R: Do you get this often?
P: Yes.
R: For now you can take RRR, but you should really see your doctor. You might need more medication to treat the problem.

Scenario #7:
P: I have a headache. What can I take for it?
R: Are you allergic to any medication?
P: No.
R: Are you taking any blood pressure medications?
P: Yes.
R: In that case you can take WWW. Take one or two tablets by mouth every 4-6 hours as needed.

Scenario #8:
P: My son has a rash on his arm. Can you tell me what he can use for it?
R: How long has he had the rash?
P: Since yesterday.
R: You can either buy some of XXX ointment or cream over the counter or have him take a teaspoonful of the YYY elixir every 6 hours. But remember that the oral medication might make him sleepy.
P: He has to be in school during the day.
R: So just apply the cream to the affected site twice a day and give him the elixir at night time.

Scenario #9:
P: I am a diabetic and need something for my cold. What can I take?
R: You need to get something that is sugar free and alcohol free. What symptoms do you have?
P: I have a headache, runny nose, and congestion.
R: Do you also have a fever?
P: No.
R: How about a cough?
P: Yes. I have been coughing as well.
R: You can take YYY for your cough and ZZZ for your headache, runny nose, and congestion.

Scenario #10:
P: What do you recommend for weight loss?
R: I recommend diet and exercise.
P: Are there any pills over the counter that I can take?
R: There are some over the counter pills that claim they result in weight loss.
P: Which one will help me lose weight?
R: I still recommend diet and exercise, but you can also try this product. Take one tablet by mouth 2-3 times a day. You can also talk to your doctor about it.
P: Can I by XXX over the counter.
R: No. That is a medication that requires a prescription. You need to see a doctor for that.
P: Thank you.

Scenario #11:
P: Can I take something over the counter for cholesterol?
R: There is a product over the counter called PPP and you can take that for a few months. However you need to talk to your doctor first. There are prescription drugs that can lower cholesterol. You can also lower your cholesterol with diet and exercise.
P: How about high blood pressure?
R: Same thing. You can lower your blood pressure with diet and exercise.
P: I am also a diabetic. I use insulin for that.
R: Since you are a diabetic, it is very important that you lower your cholesterol, and blood pressure. You can lower the risk of complications with you diabetes by doing so.
P: Thank you.
R: You are welcome.

Scenario #12:
P: Where are your wart remover products?
R: They are on isle 3 on the right hand side.
P: And how about your foot products?
R: They are right behind you on the left hand side.

Scenario #13:
P: What do you recommend for dry skin?
R: You can use xyz lotion.
P: Where can I find that?
R: Two isles over on your right hand side.
P: And where are your vitamins?
R: They are four isles down on the left hand side.

Scenario #14:
P: My wife burnt her hand this morning what can she put on it.
R: Are there blisters?
P: Yes but she popped them.
R: She should not have done that. But for now she can put some antibiotic cream on it a couple of times a day so it won't get infected.

Scenario #15:
P: I am always tired. What can I take for energy?
R: Are you getting enough sleep?
P: No. I have not been sleeping well.
R: Getting enough rest is very important. That is probably why you feel tired.
P: What about taking some vitamins?
R: If you do not have a good diet taking multivitamins would be a good idea but it will not necessarily help your tiredness.
P: Which multivitamin do you recommend?
R: You can take the XYZ brand. Take one tablet once a day with your breakfast.

Scenario #16:
P: What can I use for sunburn?
R: How bad is it?
P: I am in a lot of pain.
R: You can take some anti-inflammatory pills. You can also rub some XYZ gel or cream on it. Also drink lots of fluid. Meanwhile you must stay out of the sun.
P: Ok.
R: Make sure you were suntan lotion next time. Sunburn is very bad for your skin.
P: I will. Thank you.

The transcript may further comprise the following complementary sections:

Keywords
Acne
Infection
Pain
Fungus
High blood pressure
Heart
Headache
Insomnia
Bones
Arthritis
Birth control
Hormone replacement
Bleeding
Blood thinner
Itching
Allergic reaction
Asthma
Inflammation
Stomach
Acid reducer
Diabetes
Diet (loosing weight)
Cholesterol
Glaucoma
Cataracts
Ears
Depression
Anxiety
Allergies
Warms
Leg cramps
Warts
Herpes
Cold sores
Cancer
Anemia
Conjunctivitis
Nutritional supplement
Infertility
Psoriasis
Edema/swelling
Incontinence
Ulcers
Malaria
Thyroid
Parkinsonism
Ulcerative colitis
Sunburn
Viral infection
Yeast infection
Prostate
Erectile dysfunction
Muscle cramps/spasms
Gout
Urinary track infection
Diarrhea
Constipation
Seizures
Cold/flu
Cough
Congestion
Earache
Runny nose/eyes
Colonoscopy
Nausea
Vomiting
Arrhythmia
ADHD
Dementia
Alzheimer
Vitamin deficiency
ADIS
Diaper rash
Hemorrhoids
Anesthetic
Vaginal infection
Shortness of breath
Fever
Eczema
Before
After
With food
With water
No alcohol
By mouth
Vaginally
Rectally
One-half

Important Verbs
Give
Take
Drink
Apply
Insert
Chew
Inject
Shake well
Refrigerate
Finish/until gone
Swish
Spit
Swallow
Instill
Wash
Leave on
Rub in
Massage in
Shampoo
Stop taking

Important Nouns
Tablet
Capsule
Pills
Lotion
Cream
Ointment
Drops
Teaspoonful
Tablespoonful
Dropperful/Half a dropperful
MLs
CCs
Suppositories
Intramuscularly
Subcutaneously
Intravenously
Prescription

Important Units of Time/Temporal Events
Every Hour
Every 4-6 hours
Before meals
After meals
As needed
In the morning
In the afternoon
In the evening
At night
Bedtime
Every day
Once a day
Twice a day
Three times a day
Four times a day
Every other day

Common Side Effects:
Rash
Drowsiness
Dizziness
Headache
Upset stomach
Diarrhea
Constipation
Loss of appetite
Nausea and vomiting
Muscle pain
Fatigue/tiredness
Redness
Itching
Burning
Discoloration of urine
Increased urine
Skin irritation
Insomnia
Skin sensitivity to sun/burn easily

FIG. 5. is a diagram depicting a transcript 500 drafted in a foreign language according to the present invention. The transcript 500 comprises questions 502 and answers 504 which an employee may utilize to converse with a customer. According to this embodiment, the employee is only slightly familiar with the foreign language. Due to the repetition of phrases, patterns, and high-frequency words that occur in a particular department, for instance a drop-off window section as discussed above, the questions 502 and answers 504, included in the transcript 500, contain a substantial amount of the speech required to converse with the customer and complete the transaction. As discussed above, the transcript 500 may be memorized, viewed, listened to, or utilized in any other manner which enables the employee to communicate with the customer.

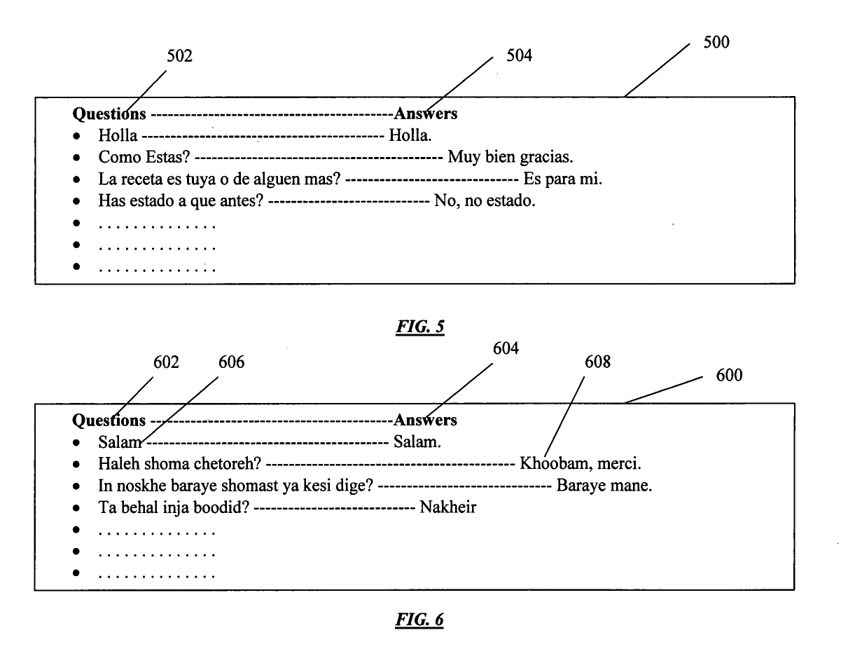

FIG. 6. is a diagram depicting a transcript 600 drafted in a foreign language according to the present invention. The transcript 600 comprises questions 602 and answers 604 which an employee may utilize to converse with a customer. According to this embodiment, the employee is not familiar with the foreign language to the extent that the letters of the foreign language is different from the letters of the formal language. Accordingly, the words of the foreign language are drafted using the letters of the formal language. For instance, “Salam” 606 means “Hello” in Persian, and the written words are drafted using Arabic letters. According to this embodiment, the word “Salam” 606 is written using the English letters. Similarly, “Khoobam merci” 608 means “Fine, thank you” in Persian using the English letters. An employee, who is not familiar with the Persian language, may nevertheless use this transcript to converse with the customer. Due to the repetition of phrases, patterns, and high-frequency words that occur in a particular department, for instance a pick-up window section as discussed above, the questions 602 and answers 604, included in the transcript 600, contain a substantial amount of the speech required to converse with the customer and complete the transaction. As discussed above, the transcript 600 may be memorized, viewed, listened to, or utilized in any other manner which enables the employee to communicate with the customer.

What is claimed is:

1. A method for eliminating a need to employ a bilingual person in an enterprise, wherein said need arises in a verbal exchange between a first person, conversing in a first language, and a second person, conversing in a second language, comprising:
(a) providing said first person with a transcript, wherein said transcript is drafted in said second language and comprising one or more questions and one or more answers corresponding to said one or more questions; and
(b) viewing said transcript on a tangible medium to ask of said second person said one or more questions to retrieve said one or more answers from said second person thereby enabling said first person to converse in said second language with said second person.

2. The method of claim 1, wherein said enterprise comprises at least one of a pharmacy and department store.

3. The method of claim 2, wherein said pharmacy comprises a compartment which includes at least one of a drop-off window department, pick-up window department, and inside department and wherein the one or more questions and the one or more answers pertain to the corresponding department.

4. The method of claim 1, wherein the first language is English and the second language is at least one of Persian, Spanish, French, and Italian.

5. The method of claim 1, wherein the transcript comprises a copyrightable transcript.

6. The method of claim 1, wherein the transcript is drafted in said second language utilizing letters of said first language.

7. The method of claim 1, wherein said tangible medium comprises at least one of a paper, compact disc, and computer screen.

8. A computer program embodied on a computer readable medium for eliminating a need to employ a bilingual person in an enterprise, wherein said need arises in a verbal exchange between a first person, conversing in a first language, and a second person, conversing in a second language, comprising:
(a) a code segment that generates a transcript in said second language and comprising one or more questions and one or more answers corresponding to said one or more questions; and
(b) a code segment that enables said first person to view said transcript on a tangible medium to ask of said second person said one or more questions to retrieve said one or more answers from said second person thereby enabling said first person to converse in said second language with said second person.

9. The computer program of claim 8, wherein said enterprise comprises at least one of a pharmacy and department store.

10. The computer program of claim 9, wherein said pharmacy comprises a compartment which includes at least one of a drop-off window department, pick-up window department, and inside department and wherein the one or more questions and the one or more answers pertain to the corresponding department.

11. The computer program of claim 8, wherein the first language is English and the second language is at least one of Persian, Spanish, French, and Italian.

12. The computer program of claim 8, wherein the transcript comprises a copyrightable transcript.

13. The computer program of claim 8, wherein the transcript is drafted in said second language utilizing letters of said first language.

14. The computer program of claim 8, wherein said tangible medium comprises at least one of a paper, compact disc, and computer screen.

15. A system for eliminating a need to employ a bilingual person in an enterprise, wherein said need arises in a verbal exchange between a first person, conversing in a first language, and a second person, conversing in a second language, comprising:
(a) logic that provides said first person with a transcript, wherein said transcript is drafted in said second language and comprising one or more questions and one or more answers corresponding to said one or more questions; and
(b) logic that enables said first person to view said transcript on a tangible medium to ask of said second person said one or more questions to retrieve said one or more answers from said second person thereby enabling said first person to converse in said second language with said second person.

16. The system of claim 15, wherein said enterprise comprises at least one of a pharmacy and department store.

17. The system of claim 16, wherein said pharmacy comprises a compartment which includes at least one of a drop-off window department, pick-up window department, and inside department and wherein the one or more questions and the one or more answers pertain to the corresponding department.

18. The system of claim 15, wherein the first language is English and the second language is at least one of Persian, Spanish, French, and Italian.

19. The system of claim 15, wherein the transcript comprises a copyrightable transcript.

20. The system of claim 15, wherein the transcript is drafted in said second language utilizing letters of said first language.

21. The system of claim 15, wherein said tangible medium comprises at least one of a paper, compact disc, and computer screen.

22. A method for eliminating a need to employ a bilingual person in an enterprise, wherein said need arises in a verbal exchange between a first person, conversing in a first language, and a second person, conversing in a second language, comprising:
(a) providing said first person with a means to memorize a transcript, wherein said transcript is prepared in said second language and comprising one or more questions and one or more answers corresponding to said one or more questions;
(b) memorizing said transcript to ask of said second person said one or more questions to retrieve said one or more answers from said second person thereby enabling said first person to converse in said second language with said second person.

23. The method of claim 22, wherein said means comprises at least one of a paper, compact disc, and a computer screen.
